(19) United States
(12) Patent Application Publication
(10) Pub. No.: US 2006/0179001 A1
(43) Pub. Date: Aug. 10, 2006

(54) Method of generating usage rule information for broadcast channel

(75) Inventors: Myung-sun Kim, Uiwang-si (KR); Young-sun Yoon, Suwon-si (KR); Sung-hyu Han, Seoul (KR); Sun-nam Lee, Suwon-si (KR); Jae-heung Lee, Suwon-si (KR); Bong-seon Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/348,236

(22) Filed: Feb. 7, 2006

Related U.S. Application Data
(60) Provisional application No. 60/650,123, filed on Feb. 7, 2005.

(30) Foreign Application Priority Data
Mar. 23, 2005 (KR) 10-2005-0024086

(51) Int. Cl. G06Q 99/00

(52) U.S. Cl. 705/57

(57) ABSTRACT

A method of generating usage rule information for a broadcast channel. The method includes receiving content and a broadcast flag via the broadcast channel, creating content usage rule information to allow all operations relating to use of the content when the broadcast flag is off, and creating usage rule information to forbid copying of the content when the broadcast flag is on.

### CROSS-REFERENCE TO RELATED PATENT APPLICATIONS

This application claims priority from Korean Patent Application No. 10-2005-0024086, filed on Mar. 23, 2005, in the Korean Intellectual Property Office, and U.S. Provisional Application No. 60/650,123, filed on Feb. 7, 2005, in the United States Patent and Trademark Office, the disclosures of which are incorporated herein in their entirety by reference.

### BACKGROUND OF THE INVENTION

1. Field of the Invention

Methods consistent with the present invention relate to generating usage rule information, and more particularly, to generating usage rule information for controlling the use of content imported via a broadcast channel.

2. Description of the Related Art

A content provider transmits digital content to a user. Digital content must be protected so that only a user who pays to acquire a right to use the digital content can use the digital content.

FIG. 1 illustrates a home network. In FIG. 1, a content provider CP transmits content 110 and copy control bits 112 to a home network HN via a transmission channel CH. The home network HN includes a home server HS and user devices D1, D2, and D3.

The copy control bits 112 specify restrictions on the use of content. If the transmission channel CH is a broadcast channel, the copy control bits 112 may be copy control information (CCI) specifying whether the content is ‘copy free’, ‘copy once’, ‘copy no more’, or ‘copy never’.

The home server HS uses the content according to the restrictions on the use of content specified by the copy control bits 112. For instance, the home server HS does not allow ‘copy once’ content stored in a device to be transferred to another device.

Recent advancements in digital rights management (DRM) and home networking has resulted in various ways of using content and an increased need for transmitting content to another user's device or a device governed by a different DRM system. Accordingly, a home server should change copy control bits received from the outside according to the way in which a user uses the content in a home network, and in this case, the content must be kept properly protected.

In particular, as of July of 2005, the U.S. Federal Communications Commission (FCC) requires a standard for digital broadcasting technology that prescribes that a one-bit broadcast flag (BF) be included in high-definition (HD) content which is to be broadcast as a digital broadcast throughout the U.S.A. Further, the US FCC standard requires that content protection be enabled when the BF of content is one, so that unauthorized users cannot use the content. Therefore, there is an urgent need for usage rule information supporting various uses of content while guaranteeing secure use of digital broadcast content between a home server and a user device.

### SUMMARY OF THE INVENTION

The present invention provides a method of generating usage rule information supporting various uses of different content while guaranteeing secure use of content imported via a broadcast channel.

According to one aspect of an exemplary embodiment of the present invention, there is provided a method of generating usage rule information for a broadcast channel, the method comprising receiving content and a broadcast flag via the broadcast channel; creating content usage rule information to allow all operations relating to use of the content when the broadcast flag is off; and creating usage rule information to forbid copying of the content when the broadcast flag is on.

The method further includes when a user inputs a command indicating that the content is to be copied to a destination device, performing proximity checking on the destination device and determining whether copying of the content is to be allowed.

When a user inputs a command indicating that the content is to be copied to a destination device, performing proximity checking on the destination device and determining whether copying of the content is to be allowed, comprises measuring a time-to-live time between the destination device and a home server by transmitting a test packet from the home server to the destination device, and comparing the time-to-live time with a predetermined threshold to determine whether the destination device passes proximity checking.

According to another aspect of an exemplary embodiment of the present invention, there is provided a method of generating usage rule information for a broadcast channel, the method including receiving content and copy control information via the broadcast channel; creating usage rule information to allow only real-time reproduction and storing of the content when the copy control information indicates that the content is ‘copy once’; changing the usage rule information to allow one or more of a stored play operation, a moving operation, a migrating operation, an exporting operation, and an editing operation for editing the content to be performed after one of real-time reproduction and storing of the content is completed.

The method further includes creating usage rule information allowing only the real-time reproduction of the content when the copy control information indicates that the content is ‘copy never’, and when the user inputs a command indicating that the content is to be exported, determining whether exporting of the content is to be performed depending on whether an object of exporting is a protocol for real-time reproduction.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a conventional home network;

FIG. 2 illustrates a flow of content according to an exemplary embodiment of the present invention;

FIG. 3A is a block diagram of a DRM system supporting a method of generating usage rule information according to an exemplary embodiment of the present invention;

FIG. 3B is an apparatus which receives broadcast content according to an exemplary embodiment of the present invention;

FIG. 4 is a table illustrating whether BF's are mapped to usage rule information according to an exemplary embodiment of the present invention;

FIG. 5 is a table illustrating whether CCI is mapped to usage rule information according to an exemplary embodiment of the present invention;

FIG. 6 illustrates the syntax of a license containing usage rule information according to an exemplary embodiment of the present invention;

FIG. 7 is a flowchart of a method of generating usage rule information when copy control bits correspond to a BF according to an exemplary embodiment of the present invention; and

FIG. 8 is a flowchart of a method of generating usage rule information when copy control bits correspond to CCI according to another exemplary embodiment of the present invention.

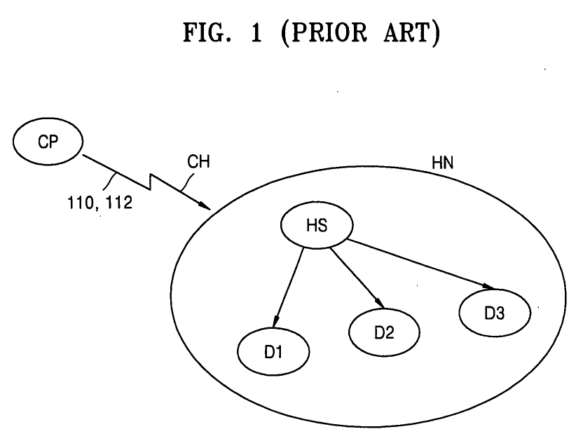

### DETAILED DESCRIPTION OF THE INVENTION

Exemplary embodiments of the present invention will now be described in detail with reference to the accompanying drawings.

A DRM system according to an exemplary embodiment of the present invention allows a user to use content while abiding by usage rules and protects digital content imported to the user's home via a variety of different channels. Hereinafter, a method of generating usage rule information applicable to the DRM system, particularly, for content imported via a broadcast channel, will be described. First, technical usage models will be described.

The exemplary embodiment of the present invention adopts one of two different types of usage models depending on a content source.

One of the usage models is a terrestrial channel. Content imported via the terrestrial channel is accompanied by a BF having a value of zero or one.

As described above, as of July of 2005, the U.S. FCC requires a standard for digital broadcasting technology that prescribes that a one-bit BF be included in HD content to be broadcast as a digital broadcast throughout the U.S.A., and that content protection be enabled when the BF of content is one so that unauthorized users cannot use the content.

The other usage model is a cable channel. Content imported via the cable channel is accompanied by CCI which specifies whether the content is ‘copy free’, ‘copy once’, ‘copy no more’, or ‘copy never’.

The detected BF or CCI of the content is used to reproduce usage rule information. That is, a home server in a home network creates the usage rule information based on the BF or the CCI. A technique of detecting CCI/BF bits does not fall within the scope of the present invention and thus will not be described.

Technical usage models exemplifying use and protection of content according to a DRM system of an exemplary embodiment of the present invention are as follows:
(1) Create usage rule information regarding imported content.
(2) Stream content and reproduce stored content.
(3) Reproduce content while storing the content using time shifting.
(4) Transmit content between devices.
(5) Exchange content between two domains.
(6) Export content to a device governed by a different DRM system.
(7) Edit content, e.g., create or divide the content, or combine the content with other content.
(8) Manage domain for authentic sharing of content.
(9) Prevent a hacked device from accessing.

In this disclosure, words such as “must”, “must not”, “required”, “shall not”, “recommended”, and “optional” are to be interpreted as defined in Request for Comments, RFC2119.

The overall structure of a DRM system according to an exemplary embodiment of the present invention, and a method of controlling distribution and use of content will now be described.

First, the operations of the DRM system and entities related to the use of the content according to the DRM system will be described. The DRM system manages the use of content by various entities according to restrictions and permissions given by a content provider. The DRM system creates usage rule information using BF/CCI bits, and translates the usage rule information and limits use of the content based on the translated usage rule information when an entity accesses the content.

Entities related to use of content according to the DRM system of an exemplary embodiment of the present invention are as follows:
User: An entity that uses content.
Content provider: An entity that broadcasts a BF or CCI to a user.
Device: An entity, e.g., consumer electronic devices such as a personal computer (PC), through which a user uses content. The DRM system according to an exemplary embodiment of the present invention is applicable to a wide variety of devices ranging from offline-tethered devices to Internet-enabled devices with a large capacity.
DRM System according to an exemplary embodiment of the present invention: An entity that governs a user's use of content and is deployed in compatible devices. The DRM system creates usage rule information, enables domain management, and performs device revocation.

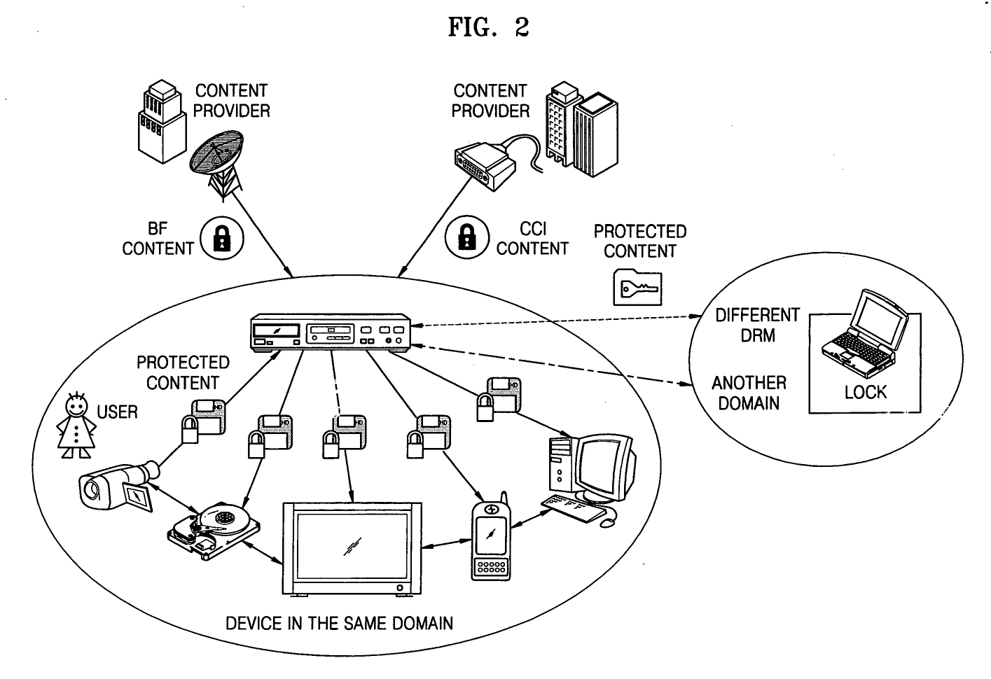

FIG. 2 illustrates a flow of content according to an exemplary embodiment of the present invention. Content broadcast to a user is packaged with usage restrictions. Usage restrictions for terrestrial content are provided in the form of a BF, and usage restrictions for cable content are provided in the form of CCI.

When a device detects BF/CCI bits, a DRM system according to an exemplary embodiment of the present invention translates the BF/CCI bits into a rights object. The rights object includes the BF/CCI bits and further includes binding information of content, for example, that the content is bound to a user. The rights object controls the overall use and consumption of the content. A user of a domain may add as many devices to the domain as allowed. Also, the user may remove a device from the domain.

When content is transmitted, the content is bound to a designated user according to the DRM system unless the content violates compliance rules. In this way, the designated user can make use of the content using a device in the domain. However, if the use of the content violates the compliance rules, the content must be bound to the device. The DRM system determines whether the content can be streamed, stored, and copied based on the usage rule information.

The DRM system allows content not only to be migrated to other domains but also to be exported to different DRM systems. There is no need to modify the format of content or usage rule information for migration, since they can be interpreted directly. However, the format of content or usage rule information for exportation must be modified properly.

The user may edit content to an extent permitted by the usage rule information. If permitted, the user can divide the content into pieces, and each piece of the content contains its related usage rule information. The DRM system generates usage rule information for each piece of the content.

During domain management, migration, and exportation, the DRM system allows only authenticated users or devices to access the content. The DRM system has information on revoking the devices. Hacked devices are not permitted to access the content protected in the domain since the content is protected using the revocation information. To provide the latest revocation information, the DRM system provides a renewal mechanism. Renewal of revocation information is guaranteed through synchronization of information between two devices under control of the domain.

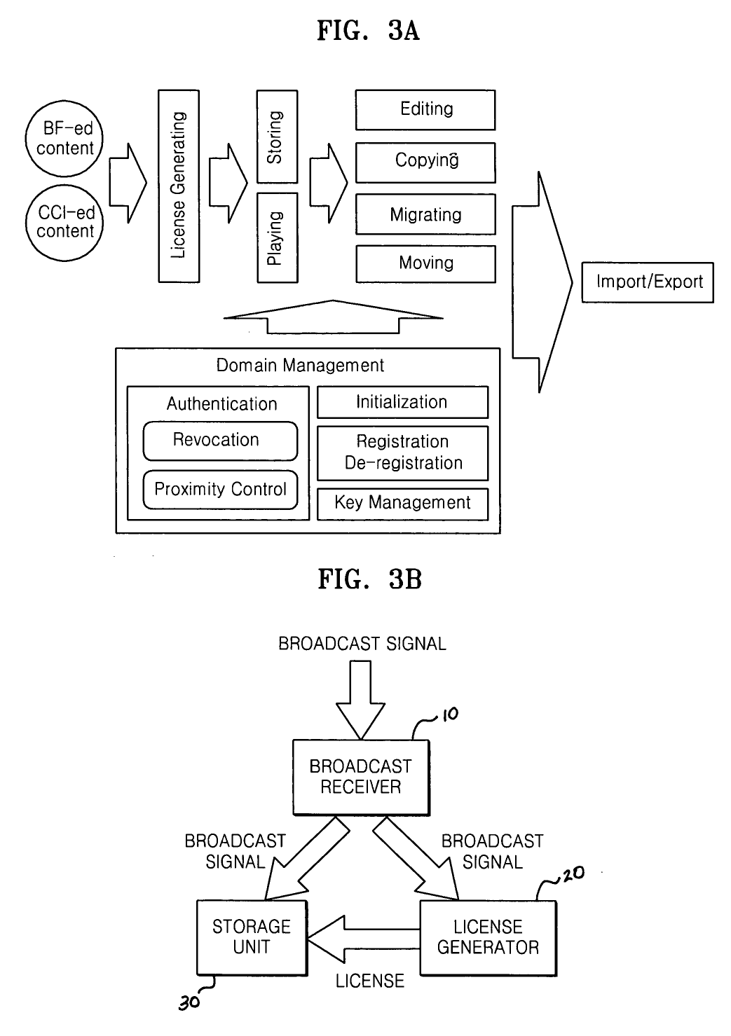

FIG. 3A is a block diagram of a DRM system supporting a method of generating usage rule information according to an exemplary embodiment of the present invention. FIG. 3B is an apparatus which receives broadcast content according to an exemplary embodiment of the present invention.

A method of generating usage rule information according to an exemplary embodiment of the present invention is expected to support the followings operations:

1. Reproduction

A DRM system according to an exemplary embodiment of the present invention does not limit the type of device that can play content for the following two cases:
Real-time reproduction of content (live playing)
Reproduction of content stored in a device, such as a set-top box (STB) with a hard disk drive (HDD), in a domain (stored playing). In this case, when the content is packaged, removal of packaging is required.
   2. Storing

A user can store content if storage is allowed by usage rule information. To store the content in a target device, the DRM system creates usage rule information bound to the content. The content is bound to a user if this is allowed; otherwise, the content is bound to a device. For example, there is an operation for automatically storing content, which supports time shifting enabled by a content receiver such as a STB. A time limit for the operation is determined according to compliance rules and should conform to the compliance rules. After the time limit passes, the stored content must be completely removed from a storage unit of the STB.

3. Copying

When content is bound to a user, the DRM system allows the user to share content between devices belonging to the user's domain. Since the content is stored together with its usage rule information, it is possible to determine whether the content can be copied. Alternatively, the DRM system may force a source device to check whether a sink device is located close enough to the source device before the content is transmitted from the source device to the sink device.

4. Moving

The DRM system can allow a user to move content from one device to another device. In general, there are two types of content: movable content and immovable content. Alternatively, a source device may verify whether a sink device is an authorized device through proximity checking for movement of the content.

5. Migrating

Some content can be copied from a domain to another domain to which another user belongs. Migration is allowed depending on usage rule information regarding the content. Alternatively, a revocation key protects the content from hacked devices or incompatible devices. To allow interoperability between Marlin DRM implementations, content must be packaged such that the content can be imported by Marlin DRM implementations without additional effort.

6. Importing/Exporting

Content can be exported to other DRM systems or technologies for content protection such as content protection for removable media (CPRM) and digital transmission content protection (DTCP). Thus, usage rule information regarding content may further specify whether the content can be exported. The DRM system according to an exemplary embodiment of the present invention guarantees that content remains protected during exporting of the content.

7. Editing

The DRM system according to an exemplary embodiment of the present invention allows a user to edit stored content. Content newly generated by editing is assigned separate usage rule information.

A method of generating usage rule information supporting the above operations will be described. A user may create a domain and share content between devices belonging to the domain. In the domain, the user may reproduce, store, copy, or move content within an allowed range. If the user wants to transfer content to another domain, the user must perform a migration operation on the content. To transfer content to a domain governed by a DRM system different to that adopted by an exemplary embodiment of the present invention, the user must perform an exporting operation on the content. The user may become a content provider who creates, edits, and provides the content.

A license is allocated to each piece of content, which includes usage rule information for the content. The usage rule information describes constraints on the use of the content.

Content imported to a home server in a home network at a wide band of frequencies or under. Open Mobile Alliance (OMA) DRM is accompanied by usage rule information. In contrast, content imported via a broadcast channel such as a terrestrial channel or a cable channel or imported via a physical medium such as a digital versatile disk (DVD) or a Blu-ray disk (BD), is not accompanied by usage rule information. As a substitute for usage rule information, copy control bits can be used to limit the use of content. Copy control bits are referred to as a BF in the case of a terrestrial channel, and referred to as CCI in a case of the cable channel or a physical medium.

As describe above, according to the DRM system, content should be used according to its usage rule information. This means that the original license for the content should be mapped to a license supported by the DRM system, and the BF or the CCI of content imported via a broadcast channel must be securely translated using the same usage rule information. The exemplary embodiment of the present invention supports a method of generating usage rule information for content imported via a broadcast channel.

In FIG. 3B, a broadcast receiver 10 receives a broadcast signal which contains usage control information of the broadcast content. The usage control information of the broadcast content is mapped to the usage rule information. A license generator 20 then transforms the usage control information into usage rule information. A license which contains content binding information corresponding to the usage control information is then generated. Subsequently, a storage unit 30 stores the broadcast content and the license.

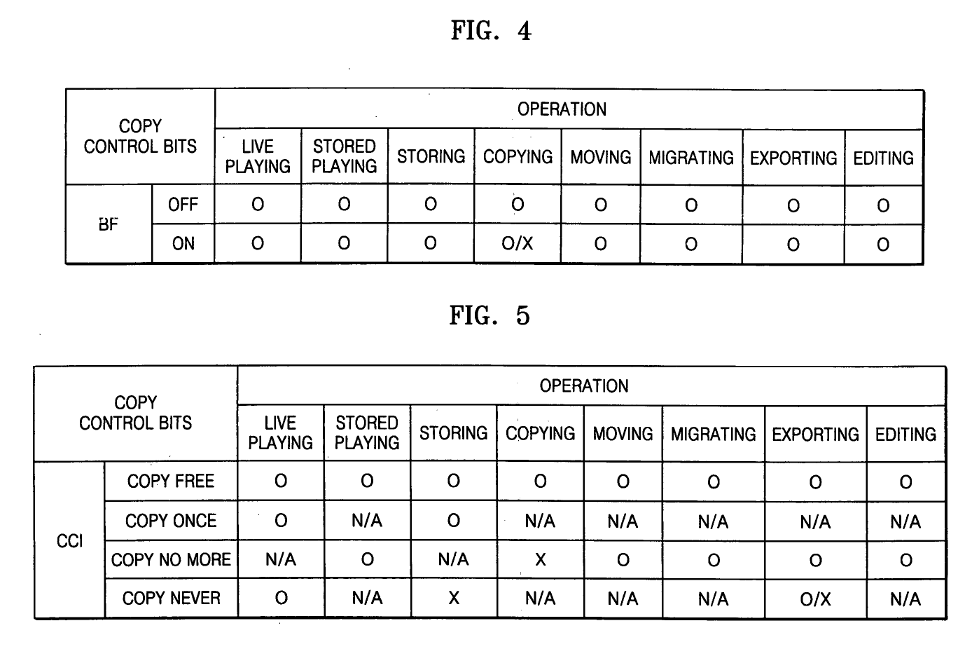

FIG. 4 is a table illustrating whether BF's are mapped to usage rule information according to an exemplary embodiment of the present invention. Referring to FIG. 4, usage rule information puts restrictions on the operations of live play, stored play, storing, copying, moving, migrating, exporting, and editing of content which have been described with reference to FIG. 3. In FIG. 4, whether the above operations are allowed is indicated using “O” and “X”.

If copy control bits correspond to a BF, the usage rule information is created to permit all the above operations except the copying operation. The BF is used to prevent content from being unlimitedly redistributed, and thus, all the above operations except the copying operation are allowed.

Whether the copying operation will be allowed is determined by checking whether a position of content is adjacent to a destination to which the content is to be copied through proximity checking. The BF does not define usage rule information of the content in detail, since use of a BF is to prevent content from being redistributed without limitation. Further, redistribution of the content to a certain extent is allowed. Proximity checking is performed through measurement of a time-to-live time (TTL) or a round trip time (RTT) and a comparison of the measurement with a threshold.

FIG. 5 is a table illustrating whether CCI is mapped to usage rule information according to an exemplary embodiment of the present invention.

If copy control bits correspond to CCI, whether the above operations will be allowed is determined by the type of the CCI.

When the CCI indicates that content is ‘copy free’, all of the above operations are allowed in a home network. Thus, there are no restrictions on the use of the content except for restrictions regarding domain management. That is, since the content is copy free, there are no restrictions on the use and distribution of the content.

When the CCI describes that content is ‘copy once’, only the live play operation and the storing operation are permitted. This is because ‘copy once’ indicates that the content can be used only once.

After ‘copy once’ content imported to a home network is reproduced in real time or stored in the home network, a license for the ‘copy once’ content is changed to ‘copy no more’. Thus, the usage rules of ‘copy no more’ content are applied to the use of the ‘copy once’ content except the operations of live playing and storing and after the operations of live playing and storing are performed. The usage rule information if the ‘copy once’ content is changed to ‘copy no more’ content will be described later.

When the CCI indicates that content is ‘copy no more’, the following usage restrictions are applied:
There is no need to consider the operations of live playing and storing when using the ‘copy no more’ content, since the ‘copy no more’ content has changed from ‘copy once’ content, that is, the content has already been stored or reproduced in real time.
The operation of stored play is allowed, since reproduction of already stored ‘copy no more’ content is riot limited.
The copying operation is not allowed since the copying operation is an essential part of the usage rule information of the ‘copy no more’ content.
The operations of moving, migrating, exporting, and editing are allowed, since movement of ‘copy no more’ content in a domain is permitted when at least a piece of content exists in the domain. In particular, the usage rule information should be created to realize the DRM system according to an exemplary embodiment of the present invention to allow movement of content to a domain governed by a different DRM system, for example, reproduce the content in another apparatus using the DTCP.

When the CCI indicates that content is ‘copy never’, the following restrictions are applied:
The operation of live play is allowed but the operation of storing is not allowed. That is, only reproduction of the ‘copy never’ content is allowed.
There is no need to consider the operations of stored play, copying, moving, migrating, and editing, since they can be performed on an assumption that copying is allowed. As described above, storing of the ‘copy never’ content is not permitted, and thus, the above operations are also not permitted.
As a rule, the exporting operation is not permitted since storing and movement of the ‘copy never’ content are not allowed, but is exceptionally allowed where an apparatus that makes usage rule information of content does not reproduce the content but allows an apparatus governed by a different DRM system to reproduce the content using DTCP. For example, the operation of exporting is allowed when a STB receiving content delivers the content to a digital television (DTV) using the DTCP and allows the DTV to reproduce. In this case, since the operation of exporting does not violate the ‘copy never’ restraint, transmission (exporting) of content from the STB to the DTV is allowed. However, exporting of content to a storage medium using a content protection protocol such as the CPRM is not allowed, to prevent the content from being reproduced two or more times.

FIGS. 4 and 5 do not include a table illustrating whether usage rule information is mapped to the importing operation. A table illustrating whether usage rule information is mapped to the importing operation is not included because the generation of usage rule information illustrated in FIGS. 4 and 5 is included in the operation of importing, since the operation of importing is to receive content from the outside. That is, that the usage rule information illustrated in FIGS. 4 and 5 is generated means that the importing operation has already been allowed.

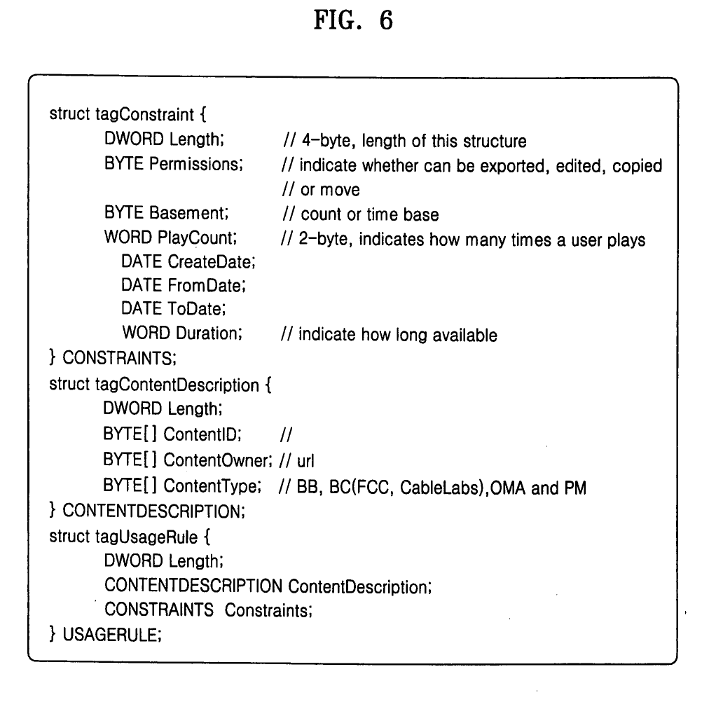

FIG. 6 illustrates the syntax of a license containing usage rule information according to an exemplary embodiment of the present invention. The usage rule information is contained in the license and controls the use of content. A domain manager in a home server extracts usage rule information from the license and limits the use of the content according to the usage rule information.

Referring to FIG. 6, an item “BYTE Permissions” presents whether the above operations are permitted, i.e., it shows the usage rule information.

The format of the syntax illustrated in FIG. 6 is a common license template to simplify a process and reduce load on a system. The common license template consists of a constraint part and a description part.

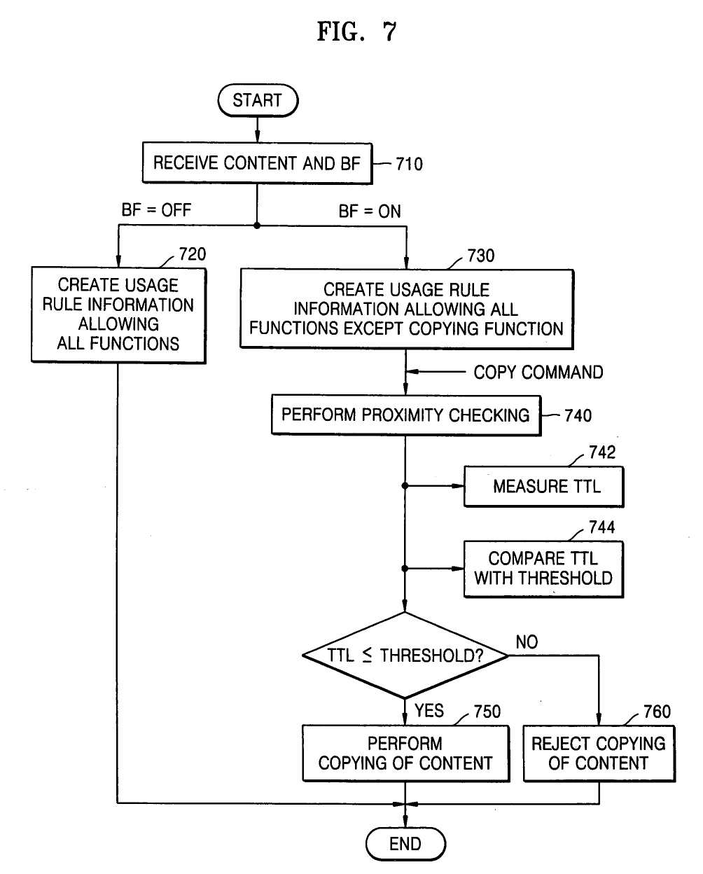

FIG. 7 is a flowchart of a method of generating usage rule information when copy control bits correspond to a BF according to an exemplary embodiment of the present invention. Referring to FIG. 7, in operation 710, a home server or a domain manager in the home server receives content and the BF from an external channel.

In operation 720, when the BF is off, the usage rule information is made to allow all the above operations including the operation of live play.

In operation 730, when the BF is on, the usage rule information is made to allow all the above operations except the operation of copying.

In operation 740, when a user inputs a command that instructs the content to be copied to a destination device, proximity checking is performed to find the distance between the position of content and the destination device. Operation 740 includes operations 742 and 744.

In operation 742, the home server measures a TTL between the destination device and the home server by transmitting a test packet to the destination device. Alternatively, the TTL may be replaced with an RTT.

In operation 744, the home server compares the TTL measured in operation 742 with a predetermined threshold to determine whether the destination device passes proximity checking. If the TTL is less than the predetermined threshold, it is determined that the target device passes proximity checking. The threshold is determined within an allowed range of distributing the content, e.g., a physical range of a home network. Since a main purpose of proximity checking is to prevent distribution of content unlimitedly, a range of the predetermined proximity threshold does not significantly affect authentication. For instance, it is possible to prevent unlimited distribution of content by limiting the physical scope of the home network to that of an apartment complex and determining the threshold RTT to be 7 ms.

If the TTL is less than or equal to the threshold, the method proceeds to operation 750; otherwise, the method proceeds to operation 760.

In operation 750, the home server performs copying of the content.

In operation 760, the home server rejects copying of the content and discontinues the method.

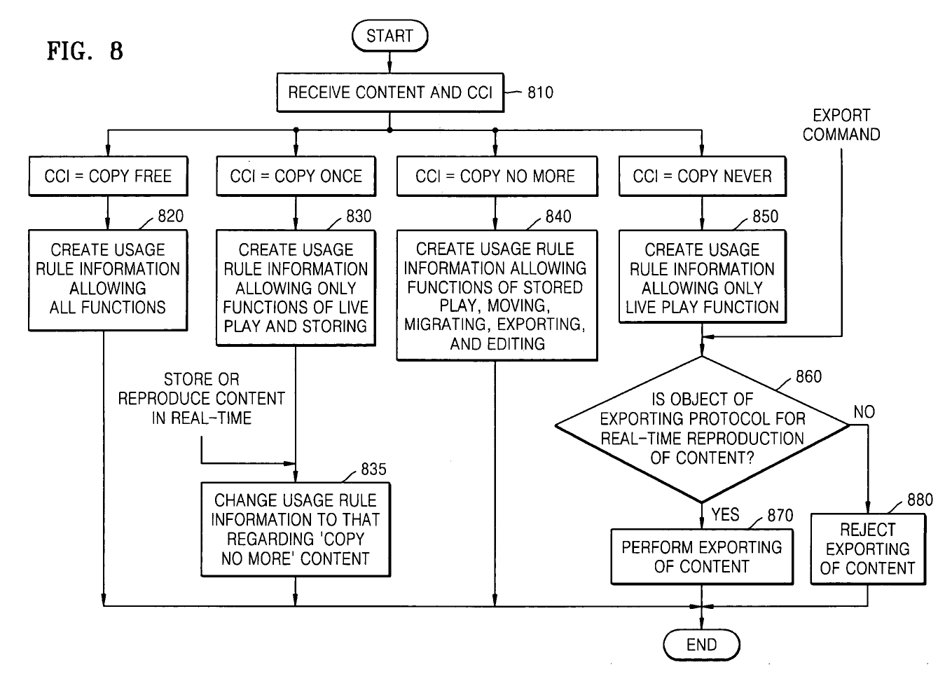

FIG. 8 is a flowchart of a method of generating usage rule information when copy control bits correspond to CCI according to an exemplary embodiment of the present invention. Referring to FIG. 8, a home server or a domain manager in the home server receives content and CCI via an external channel in operation 810.

In operation 820, when the CCI indicates that the content is ‘copy free’, the usage rule information is made to allow all the above operations including the live play operation.

In operation 830, when the CCI indicates that the content is ‘copy once’, usage rule information is created to allow only the operations of live play and storing, and then, the method proceeds to operation 835.

In operation 830, after the content is reproduced in real time or stored, the usage rule information made in operation 830 is changed to usage rule information regarding ‘copy no more’ content in operation 835.

In operation 840, when the CCI indicates that the content is ‘copy no more’, the usage rule information is created to allow only the operations of stored play, moving, migrating, exporting, and editing.

In operation 850, when the CCI indicates that the content is ‘copy never’, the usage rule information is created to allow only the operation of live play and the method proceeds to operation 860.

In operation 860, when a user inputs a command that instructs the content to be exported, the home server checks whether an object of exporting is a protocol for real-time reproduction of the content. If the object of exporting is the protocol for real-time reproduction, the method proceeds to operation 870, and otherwise, the method proceeds to operation 880. The protocol for real-time reproduction may be a DTCP. If the object of exporting is a protocol for storing the content in a storage medium such as the CPRM, the method proceeds to operation 880.

As described above, the ‘copy never’ restraint is not violated when a device, for example, the home server, which creates usage rule information of content does not reproduce the content and allows a device governed by a different DRM system to reproduce the content using the DTCP, for example, when an STB receiving the content does not reproduce the content, and transmits the content to a DTV using the DTCP and allows the DTV to reproduce the content. Thus, transmission (exporting) of the content from the STB to DTV is allowed in this case.

In operation 870, the home server performs exporting of the content.

In operation 880, the home server rejects exporting of the content and discontinues the method.

A method of generating usage rule information according to an exemplary embodiments of the present invention may be embodied as a computer program. Computer programmers in the art could have easily derived codes or code segments of the program. The program may be stored in a computer readable medium, and the method is performed when the program is read and executed using a computer. The computer readable medium may be a magnetic recording medium, an optical recording medium, and a carrier wave medium.

As described above, the exemplary embodiment of the present invention provides a method of generating usage rule information for distribution of content imported via a broadcast channel, i.e., content controlled using a BF or CCI.

In particular, according to the exemplary embodiments of the present invention, it is possible to easily deliver content to a domain governed by a different DRM system or another user's domain by changing usage rules regarding ‘copy once’ content to those regarding ‘copy no more’ content after the content is reproduced in real time or stored.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of generating usage rule information for a broadcast channel, the method comprising:
receiving content and a broadcast flag via the broadcast channel;
creating content usage rule information to allow all operations relating to use of the content if the broadcast flag is off; and
creating usage rule information to forbid copying of the content if the broadcast flag is on.

2. The method of claim 1, further comprising if a user inputs a command indicating that the content is to be copied to a destination device, performing proximity checking on the destination device and determining whether copying of the content is to be allowed.

3. The method of claim 2, wherein the performing proximity checking on the destination device and determining whether copying of the content is to be allowed comprises:
measuring a time-to-live time between the destination device and a home server by transmitting a test packet from the home server to the destination device; and
comparing the time-to-live time with a predetermined threshold to determine whether the destination device passes proximity checking.

4. The method of claim 2, wherein the performing proximity checking on the destination device and determining whether copying of the content is to be allowed comprises:
measuring a round trip time between the destination device and a home server by transmitting a test packet from the home server to the destination device; and
comparing the round trip time with a predetermined threshold to determine whether the destination device passes proximity checking.

5. The method of claim 4, wherein the predetermined threshold is a round trip time of 7 ms.

6. A method of generating usage rule information for a broadcast channel, the method comprising:
receiving content and copy control information via the broadcast channel;
creating usage rule information to allow only real-time reproduction and storing of the content if the copy control information indicates that the content is ‘copy once’;
changing the usage rule information to allow at least one of a stored play operation, a moving operation, a migrating operation, an exporting operation, and an editing operation for editing the content to be performed after one of real-time reproduction and storing of the content is completed.

7. The method of claim 6, further comprising creating usage rule information allowing only the operations of stored play, moving, migrating, exporting, and editing if the copy control information indicates that the content is ‘copy no more’.

8. The method of claim 6, further comprising creating usage rule information allowing all operations relating to copying of the content if the copy control information describes that the content is ‘copy free’.

9. The method of claim 6, further comprising:
creating usage rule information allowing only the real-time reproduction of the content if the copy control information indicates that the content is ‘copy never’; and
if the user inputs a command indicating that the content is to be exported, determining whether exporting of the content is to be performed depending on whether an object of exporting is a protocol for real-time reproduction.

10. The method of claim 9, further comprising if it is determined that the object of exporting is the protocol for real-time production, performing exporting of the content, and
wherein the object of exporting is content protected by digital transmission content protection.

11. The method of claim 9, further comprising if it is determined that the object of exporting is not the protocol for real-time production, rejecting exporting of the content, and
wherein the object of exporting is a protocol for transmission of the content to a storage medium.

12. The method of claim 9, wherein in if it is determined that the object of exporting is not the protocol. for real-time production, the protocol for transmission of the content to the storage medium is a content protection protocol for removable media.

13. A computer recording medium having embodied thereon a program for executing a method of generating usage rule information for a broadcast channel in a computer, wherein the method comprises:
receiving content and a broadcast flag via the broadcast channel;
creating content usage rule information to allow all operations relating to use of the content if the broadcast flag is off; and
creating usage rule information to forbid copying of the content if the broadcast flag is on.

14. A computer recording medium having embodied thereon a program for executing a method of generating usage rule information for a broadcast channel in a computer, wherein the method comprises:
receiving content and copy control information via the broadcast channel;
creating usage rule information to allow only real-time reproduction and storing of the content if the copy control information indicates that the content is ‘copy once’;
changing the usage rule information to allow at least one of a stored play operation, a moving operation, a migrating operation, an exporting operation, and an editing operation for editing the content to be performed after one of real-time reproduction and storing of the content is completed.

15. A method of receiving broadcast content, the method comprising:
receiving usage control information of the broadcast content;
mapping the usage control information of the broadcast content to usage rule information;
transforming the usage control information into the mapped usage rule information; and
generating a license which includes the usage rule information.

16. The method of claim 15, wherein the usage rule information is included in content control information or information regarding a scope of authority, according to the usage control information.

17. The method of claim 15, wherein the license further comprises content binding information based on the usage control information.

18. The method of claim 17, wherein the content binding information is related to binding to a user or a device.

19. The method of claim 15, wherein the usage control information is a broadcast flag.

20. The method of claim 15, wherein the usage control information is a copy control information.

21. The method of claim 15, further comprising storing the broadcast content and the license.

22. An apparatus which receives broadcast content, the apparatus comprising:
a broadcast receiver receiving a broadcast signal which contains usage control information of the broadcast content;
a license generator transforming the usage control information into usage rule information, and generating a license which contains content binding information corresponding to the usage control information; and
a storage unit storing the broadcast content and the license.

23. The apparatus of claim 22, wherein the content binding information is related to binding to a user or a device.

24. The apparatus of claim 22, wherein the usage control information is a copy control information.
